(19) United States
(12) Patent Application Publication
(10) Pub. No.: US 2008/0315614 A1
(43) Pub. Date: Dec. 25, 2008

(54) Visor and Method for Making a Visor

(75) Inventors: L.Robert Hamelink, Holland, MI (US); Scott T. Williams, Holland, MI (US); Jon Frens, Jenison, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 11/795,073

(22) PCT Filed: Dec. 28, 2005
(86) PCT No.: PCT/US05/47071

§ 371 Date: Sep. 5, 2008

Related U.S. Application Data
(60) Provisional application No. 60/643,202, filed on Jan. 12, 2005.

(51) Int. Cl. B60J 3/00

(52) U.S. Cl. 296/97.2; 264/464

(57) ABSTRACT

A visor for a vehicle includes a core portion having a hinge region and a first peripheral edge. A pliable cover material is formed with a U-shaped section extending at least partially along a second peripheral edge so that the cover material is fittable over the core portion with the U shaped section of the second peripheral edge extending over the first peripheral edge. The core portion and cover material are foldable about the hinge region so that the second peripheral edge of the cover material forms a tucked edge on the visor body.

### BACKGROUND

The present inventions relate generally to the field of components such as panels, trim components or other structures for use in vehicles (e.g., automobiles such as cars, trucks, and the like; airplanes, boats, etc.). More specifically, the present inventions relate to visors for vehicles or other applications.

Visors for use in vehicles to shield an occupant from sunlight are generally known. Such visors typically have a “butterfly” or “clamshell” type core portion at least partially covered by a cover material such as a fabric. The cover material often “overlaps” or is wrapped over the perimeter edges of the core portion so that when the core portion is “folded” about a midpoint, the perimeter edges of each half of the core portion meet and the cover material is tucked therebetween to create a “tucked edge” intended to have a “neat” aesthetically attractive appearance.

However, such visors and methods for making the visors have certain disadvantages. For example, when cover materials such as cloth and fabrics are used, the material and labor or equipment costs to tuck the fabric tend to be expensive. By further way of example, when the cover material is a synthetic material such as vinyl or plastic, wrapping the material over the core portion and then folding the core portion tends to create a poor quality appearance having defects such as “wrinkles” around curves or radii of the visor core or other undesirable effects that tend to require additional operations or effort to resolve which may reduce the cost-effectiveness of such cover materials and methods for visor applications. Certain visors may be formed with a plastic cover material that is molded over a pre-folded visor core, however, such materials typically have a “mold seam” about the perimeter of the visor that detracts from the desired appearance and does not provide a neat “tucked edge” that is usually available with cover materials such as the more expensive cloths or fabrics.

Accordingly, there is a need to provide a method for producing components such as visors or other structures for use in vehicles that includes a cover material made from vinyl, plastic or other synthetic material. There is also a need to provide components that have a neat appearance, such as a “tucked edge”. There is also a need to provide a visor having a cover material that is preformed for use with a visor core portion. There is also a need to provide a method for forming a preformed visor cover material that may include slush molding, vacuum forming, reaction injection molding, etc. There is also a need to provide a method of forming a preformed visor cover material having multiple colors or surface textures. There is also a need to provide visors and a method for making visors that may be manufactured in a relatively simple and efficient manner with reduced manufacturing and material costs. There is also a need to provide a manufacturing method for producing visors having a synthetic material with a tucked edge that utilizes existing equipment.

Accordingly, it would be desirable to provide a component such as a visor having any one or more of these or other advantageous features.

### SUMMARY

According to one embodiment, a visor for a vehicle includes a core portion having a hinge region and a first peripheral edge. A pliable cover material is preformed with a U-shaped section extending at least partially along a second peripheral edge so that the cover material is fittable over the core portion with the U shaped section of the second peripheral edge extending over the first peripheral edge. The core portion and cover material are foldable about the hinge region so that the second peripheral edge of the cover material forms a tucked edge at least partially along the first peripheral edge. The visor may include a cushion layer disposed between the core portion and the cover material. The visor may also include accessories such as mounting brackets, vanities and clips.

According to another embodiment, a method of making a visor for a vehicle includes providing a mold, introducing a material to the mold, forming a pliable skin in the mold having a U-shaped section, fitting the pliable skin over a visor core, folding the visor core to create a tucked edge appearance between abutting portions of the U-shaped section. The step of forming the pliable skin may include slush molding, vacuum forming, reaction injection molding, spray formation and compression molding. The material may be vinyl, santoprene or a thermoplastic olefin.

According to a further embodiment, another method of forming a visor is disclosed. The method includes providing a core portion having opposed panels, selecting a material for a cover configured to fit over the core portion, introducing the material to a mold, molding the material into a shape having a return bend portion extending substantially around the cover, curing the material, removing the cover from the mold, and fitting the cover over the core portion and securing the panels of the core portion together with the return bend portion at least partially therebetween to form a tucked edge. A product made according to the method is also disclosed.

### BRIEF DESCRIPTION OF THE DRAWINGS

FIG. 1 is a schematic representation of a perspective view of a cover of a visor for use in a vehicle according to an exemplary embodiment.

FIG. 2 is schematic representation of an exploded perspective view of a visor for a vehicle having a core and a cover according to an exemplary embodiment.

FIG. 3 is a schematic representation of a perspective view of a visor for a vehicle formed with a tucked edge according to an exemplary embodiment.

FIG. 4 is a schematic representation of a perspective view of a slush mold for a cover for a visor according to an exemplary embodiment.

FIG. 5A is a schematic representation of a cross sectional view of the mold of FIG. 4.

FIG. 5B is a schematic representation of a cross sectional view of the cover formed in the mold of FIG. 4.

FIG. 6 is a schematic representation of a perspective view of a vacuum mold for a cover for a visor according to an exemplary embodiment.

FIG. 7A is a schematic representation of a cross sectional view of the mold of FIG. 6.

FIG. 7B is a schematic representation of a cross sectional view of the cover formed in the mold of FIG. 6.

FIG. 8A-8D are a schematic representation of cross-sectional images of a cover applied over a core of a visor according to an exemplary embodiment.

### DETAILED DESCRIPTION

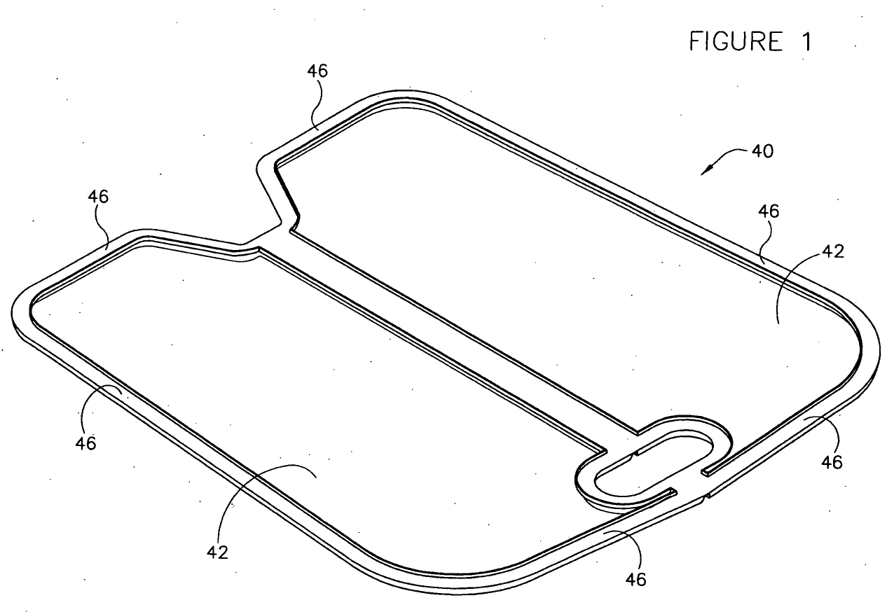

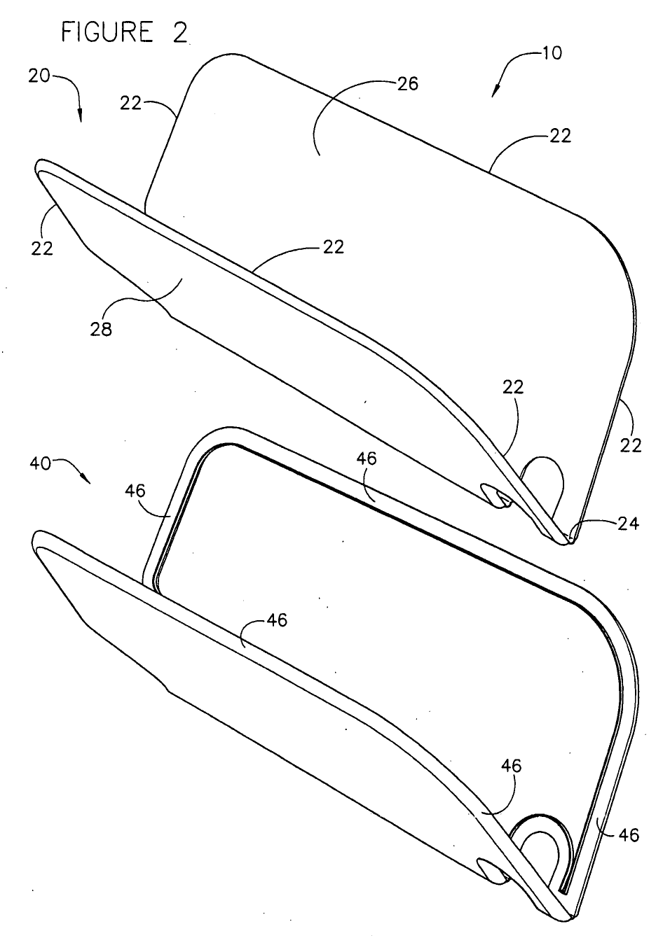

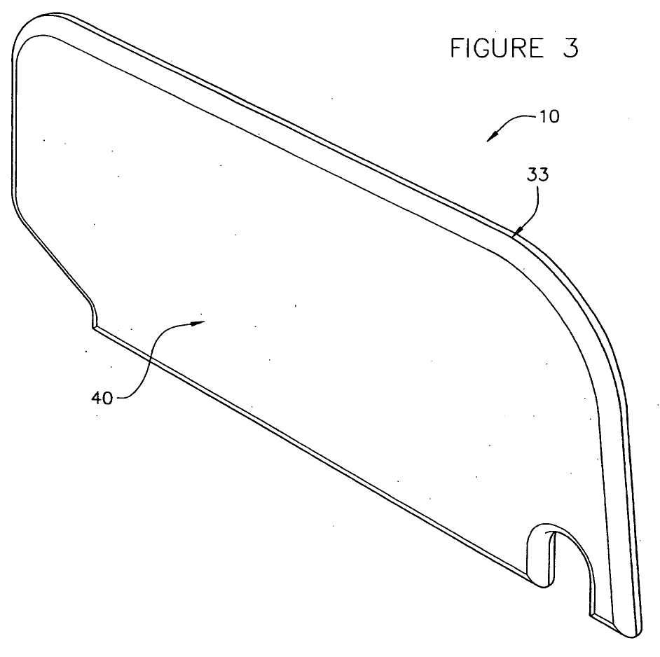

FIGS. 1-8C illustrate one exemplary embodiment of a component or assembly such as a visor for use in a vehicle (e.g., automobiles such as cars, trucks, sport utility vehicles, minivans, buses, and the like; airplanes, boats, etc.). Such components may be provided in a wide variety of sizes, shapes, and configurations according to various exemplary embodiments. All such configurations are intended to be within the scope of the inventions.

Referring to FIGS. 1-3, a component shown as a visor 10 is shown having a substrate (shown as core portion 20) and a cover material (shown as a preformed film or skin 40). Core portion 20 has a perimeter edge 22 shown to substantially surround the core portion and a central or midsection having a hinge 24 (e.g. fold line, etc.) separating two halves or panels 26, 28 of the core portion. The hinge may be a “living hinge” formed by segment having reduced thickness (e.g. by scoring, molding, etc.). According to a preferred embodiment, core portion 20 is formed from a plastic material such as plastic, PVC, polyethylene, polypropylene, copolymers, etc. Core portion 20 is intended to be foldable about hinge 24 into the shape of a visor (e.g. in a “butterfly” or “clamshell” manner). The region of the core portion having the hinge becomes the “top” portion of the visor and may be provided with a mounting bracket for mounting the visor to a vehicle. The mounting bracket may have any suitable structure (e.g. pivot rod, slide mechanism, torque clip, etc.) configured to permit a desired operation of the visor, such as swiveling between a lateral side window position and a forward windshield position, sliding between a retracted and an extended position, rotating between an upper nonuse position and a lower sun-blocking position, etc. According to alternative embodiments, a hinge may be omitted and the core may be provided in two “separate” halves or panels intended to be placed together in a facially abutting manner. Further, the core portion or panels may be made of any suitable material such as fiberboard, cardboard, expanded polypropylene, PVC, etc.

Upon folding the core portion about the hinge, the perimeter edges 22 of the core portion 20 become aligned with one another in a facially abutting manner shown as having two sides and a bottom portion that generally extend from one end of the hinge to an opposite end of the hinge. The core portion may also include coupling structure formed thereon for joining the halves of the core portion together. According to one embodiment, the coupling structure may include mating posts and apertures configured to “intermesh” or “interlock” for holding the visor. According to other exemplary embodiments, the coupling structure may include posts or other suitable structure for joining the panels in a thermal bonding process (e.g. heat staking, etc.). According to a further alternative embodiment, a bonding agent such as an adhesive material may be used to hold the panels together.

According to any exemplary embodiment, the core portion may be provided in any suitable shape and size to provide the desired component. The core portion may also be configured with suitable structure (e.g. openings, recesses, etc.) to receive a variety of accessories such as remote control devices (e.g. remote control devices such as Homelink®, etc.), vanity packs (e.g. mirrors, illumination devices, sliding or hinged covers, storage compartments, etc.), Euroclips, ticket clips, electronics, audio components, etc.

Referring further to FIGS. 1-3, the cover material is configured to cover an outer surface of the substrate (shown as panels 26, 28 of core portion 20) to provide a finished appearance that may be custom-suited to a decorative trim or finish scheme for the interior of the vehicle. According to a preferred embodiment, the cover material is “preformed” in a shape that is suited to the shape and contours of the core portion and the perimeter edges. The cover material is shown as a “preformed skin” 40 formed in a shape suited for use with the core portion 20 of the visor in its “final” (e.g. “folded” etc.) shape. Skin 40 includes a body region 42 intended for “folding” over the top portion of the visor (e.g. over the hinge or the top of the panels) and covering the external surfaces of the substrate (e.g. panels 26, 28 of the core portion 20). The skin 40 also includes a peripheral region 44 preformed with a “return” section 46 in the general form of a U-shaped section (e.g. lip, flange, etc.). The skin 40 is made of a relatively soft and pliable material such as vinyl, Santoprene®, a thermoplastic olefin (TPO), a plastisol, etc. having sufficient resiliency to fold about the hinge 24 or the top of the panels 26, 28 and fit over the peripheral edges 22 of the core portion.

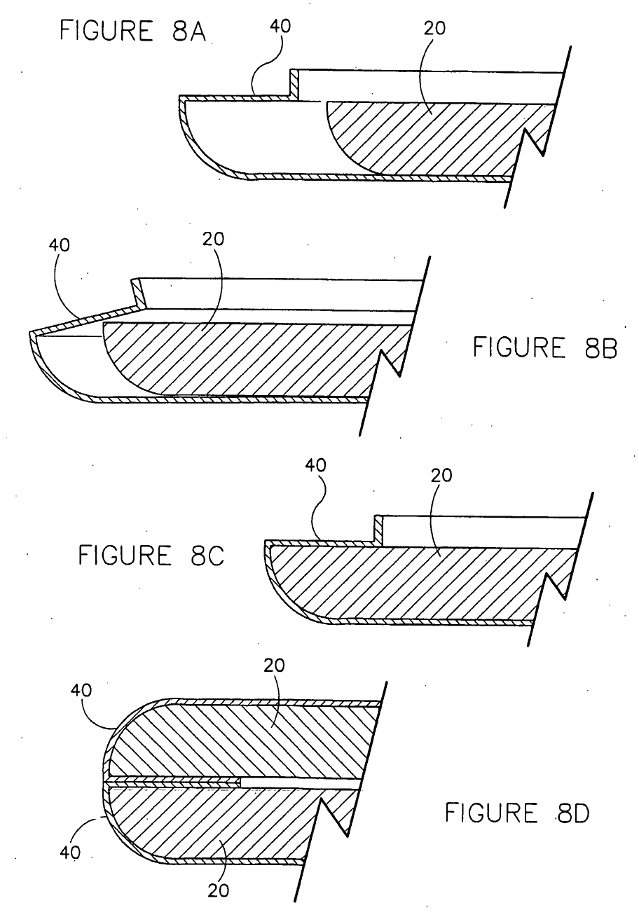

According to a preferred embodiment, the skin 40 is “fitted” over the outer surfaces of the core portion with the return section 44 fit over the peripheral edges 22 of core potion 20 (see FIGS. 8A-8C). Upon folding of the core portion (or joining of separate core panels), the return sections 44 are configured to abut each other and are held (e.g. clamped, pressed, etc.) between the bottom and side edges of the panels 26, 28 of the core portion 20 to create a “tucked edge” 30 along the sides and bottom of the visor.

With the inside surfaces of the panels 26, 28 of the core portion 20 configured in an adjacent face-to-face manner, the panels 26, 28 are joined together to form the visor and retain the return sections 44 of the skin 40 between the panels 26, 28. According to a preferred embodiment, the panels of the core portion are secured together, such as by suitable fasteners, heat staking, sonic welding, adhesives, press-fit connectors, snap-lock connectors, etc.

The skin may be configured or adapted to accommodate various accessories provided with the visor. For example, the skin may have certain contours, cutouts, etc. (e.g. preformed or created in a separate operation) to permit installation of the accessories on the visor after the skin is attached to create a neat “finished” appearance. The skin may also be formed with various surface treatments such as textures, colors, etc. The textures and/or may be generally uniform on the skin, or variations in texture and/or may be provided (e.g. a first texture and/or color on a first side of the visor and a second texture and/or color on a second side of the visor, etc.).

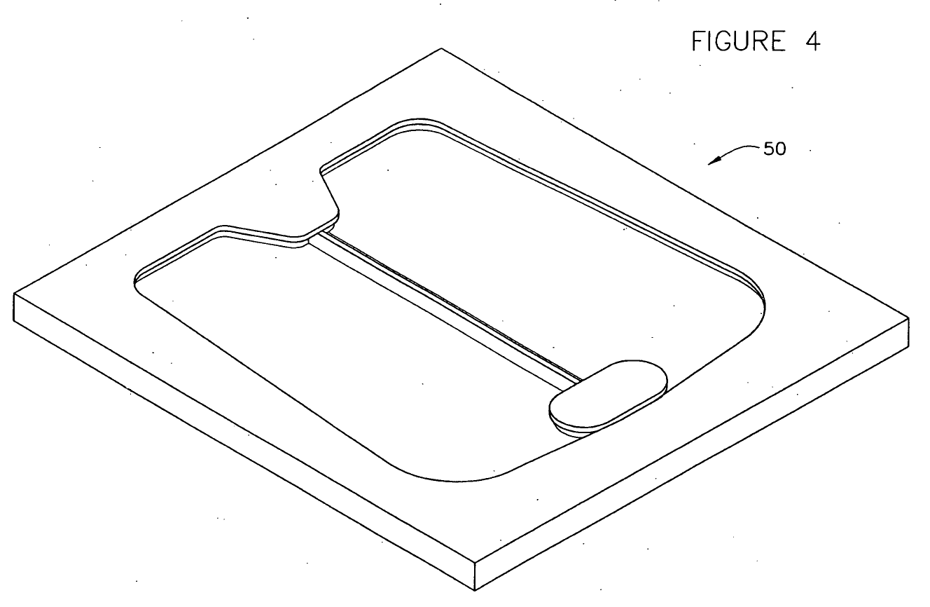

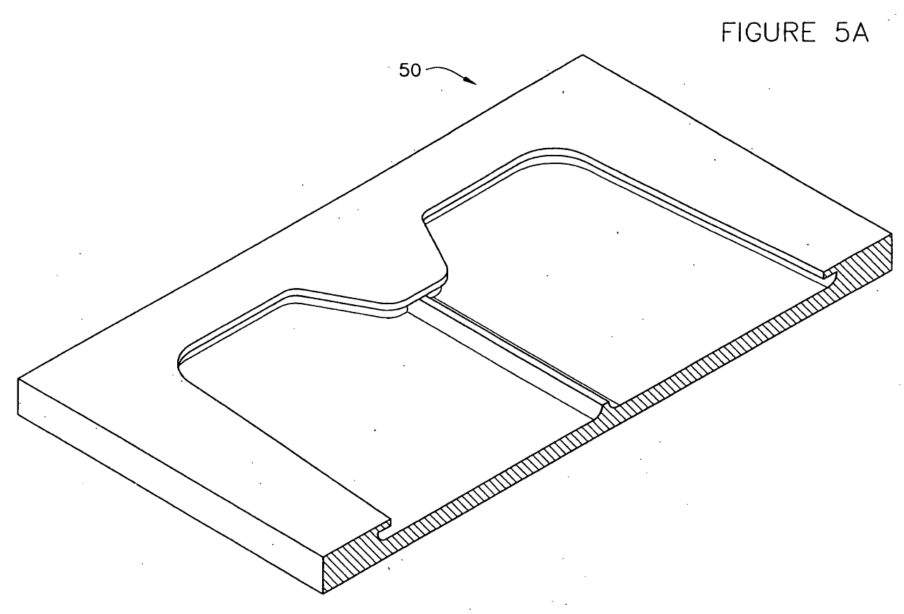

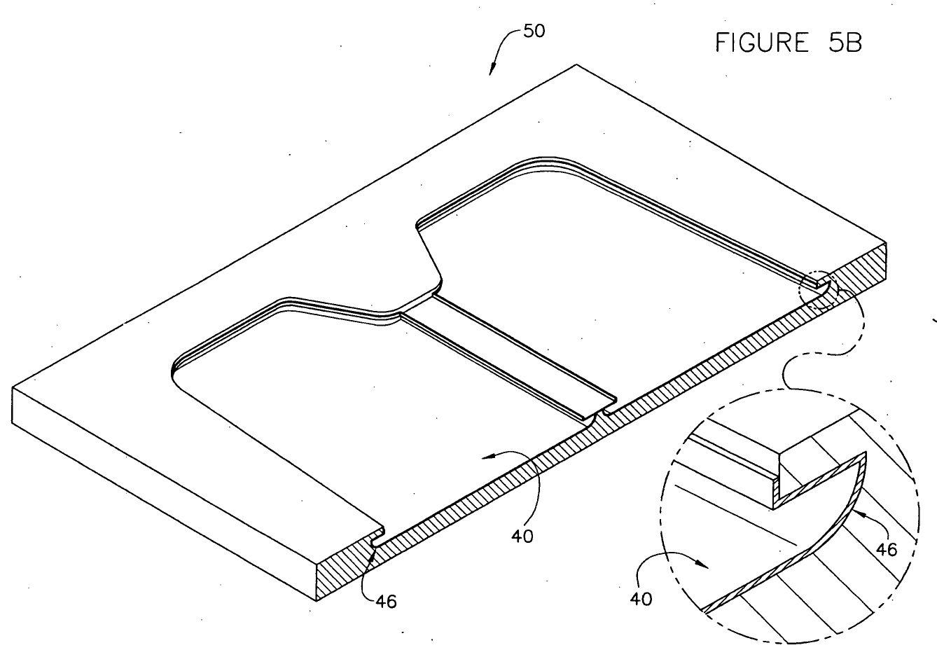

The skin may be formed in any suitable process or operation. According to a preferred embodiment, the skin is manufactured or produced utilizing a slush molding process. In a slush molding process, a thermoplastic material in a liquid or powdered form is introduced into a temperature-controlled mold (such as a mold 50 shown schematically in FIGS. 4-5) to form a viscous skin adjacent to the mold walls. Once the skin is formed, the excess material is removed from the mold and the skin is allowed to cure and cool, after which the pliable skin is removed from the mold (e.g. “demolded” etc.), trimmed (if necessary) and fitted over the visor core. One advantage of utilizing a slush molding process is that it is relatively inexpensive and efficient in producing relatively complex skin geometries. For example, the skin may be formed with a return section, U-shaped bend, undercut, etc. for providing the appearance of a “tucked edge” as would be provided using conventional materials and formation processes.

According to an alternative embodiment, the skin may be formed as a multi-colored piece by exposing only a desired first portion of the mold to the first material and then exposing a second portion of the mold to the second material, etc. Additionally, the mold may be provided with surface(s) having desired texture(s) to impart desired textures on the surfaces of the skin at desired locations.

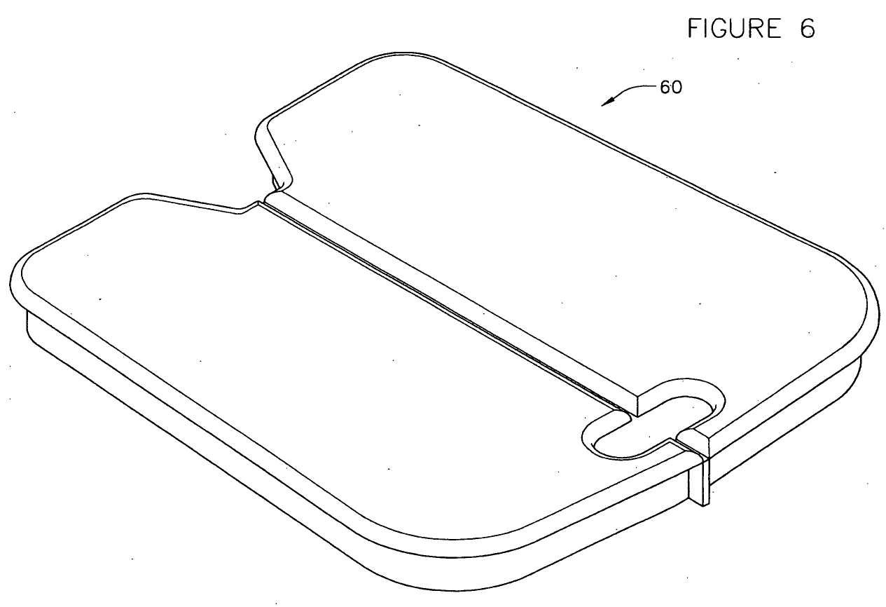

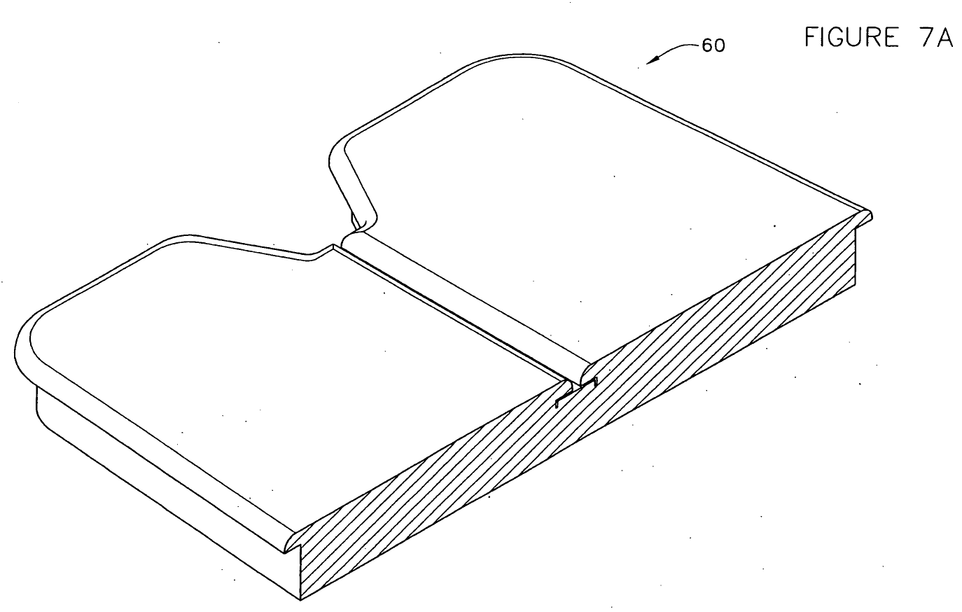

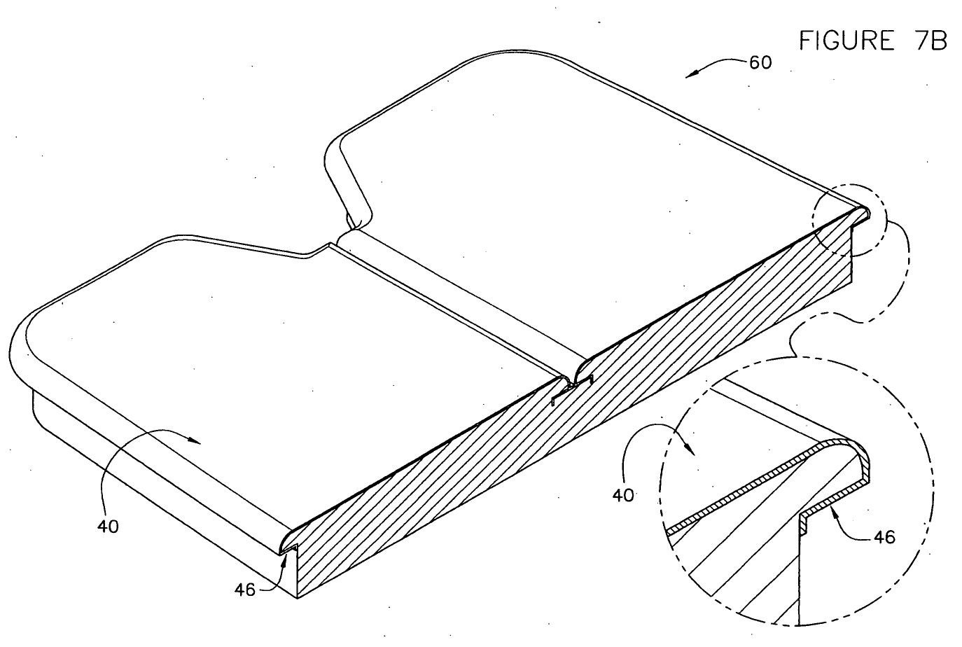

According to another embodiment, the skin is manufactured or produced utilizing a vacuum forming process. In a vacuum molding process, a pre-cut or formed sheet of polymeric material is over a mold (such as a mold 60 shown schematically in FIGS. 6-7 for example) and heated to soften the material. A vacuum is applied to the mold, which draws the softened polymeric material toward the walls of the mold. The polymeric material then cools and maintains the shape defined by the mold walls. The pliable skin may then be removed from the mold, trimmed (if necessary) and fitted over the visor core.

According to other alternative embodiments, the skin may be manufactured according to various other methods. For example, the skin may be formed in a reaction injection molding process, an extrusion process, a casting process (e.g., gravity casting), a spray urethane process (e.g. spraying a coating on the mold form), compression molding or any other suitable process for forming a polymeric skin for fitting over a substrate.

According to an exemplary embodiment in which the skin is made of a polymeric material, the skin has a thickness sufficient to provide a durable surface for the visor such as between approximately 0.2 and 5.0 millimeters, and most preferably between approximately 0.5 and 3.0 millimeters.

According to any embodiment, the skin may have a size, shape, and configuration that is adapted or configured to features included in the substrate. In one example, the substrate may include a cutout or depression, and the skin may be provided within the cutout. In another example, the skin may be applied over a protrusion formed in the substrate. The size, shape, and configuration of the skin and substrate may have any number of forms, and relatively complex geometries may be formed. One of skill in the art will appreciate that various possibilities exist in this regard.

According an alternative embodiment, an additional layer of a cushioning material may be fitted between the outer surface of the core portion and the inside of the skin to provide a “padded” or “cushioned” appearance and/or feel, the cushioning may also serve to improve the performance of the visor in the event of impact by the head of an occupant. According to a further alternative embodiment, the skin is provided on the substrate in such a manner that a space or void is formed intermediate or between at least a portion of the skin and the substrate. According to one exemplary embodiment, substantially all of the skin away from the boundary between the substrate and skin is separated from the substrate by a space or void (e.g., to form a cavity). According to an alternative embodiment, portions of the skin may be provided in direct contact with the substrate, such that one or more spaces or voids are provided between the skin and the substrate in one or more particular regions. The particular design chosen may depend on any of a variety of factors, including the desired look and feel of the outer surface of the panel, materials costs, ease of manufacturing, etc. A material (e.g., a filler material) may be provided or introduced into the space or cavity to act as a filler. It is intended that such material acts as a relatively soft or cushioning material to provide the cushioned member with at least a portion of its relatively soft or cushioned characteristic. The material may be a polymeric material such as a foam material (e.g., a urethane foam). The filler material may be provided into the cavity in liquid form and subsequently expanded to fill the cavity. For example, where a foam material is provided as a filler material, the foam reacts to expand and form a cellular structure within the cavity.

According to any preferred embodiment, a visor and method of making a visor are provided by providing a core portion having two panels (which may be hinged for folding in a clamshell manner or separate for placement in a facially abutting relationship with one another. A pliable skin material is formed in a shape intended to be fitted over the panels. The skin is formed with a return bend (e.g. retainer, lip, U-bend, undercut, etc.) intended to fit over a portion of the perimeter of the panels so that the surfaces of the return bend are adjacent one another when the core portion is folded about the hinge (or when the separate core panels are assembled in a face-to-face relationship) to form a tucked edge that fits the contours of the visor and presents a neat appearance. The skin is preferably a vinyl material of the like formed using a slush molding or vacuum forming process.

The construction and arrangement of the elements of the vehicle component as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein (e.g., the color of the skin may differ from that of the substrate or may be substantially the same color as the substrate). For example, elements shown as integrally formed may be constructed of multiple parts or elements, the position of elements may be reversed or otherwise varied, and the nature or number of discrete elements or positions may be altered or varied. It should be noted that the elements and/or assemblies of the visor may be constructed from any of a wide variety of materials that provide sufficient strength or durability, including any of a wide variety of moldable plastic materials (such as high-impact plastic) in any of a wide variety of colors, textures and combinations. Components such as those shown herein may be used in non-vehicle applications as well, including but not limited to furniture such as chairs, desks, benches, and other furniture items. Other substitutions, modifications, changes and omissions may be made in the design, operating conditions and arrangement of the preferred and other exemplary embodiments without departing from the scope of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present inventions as expressed in the appended claims.

1. A visor for a vehicle, comprising:
a core portion having a hinge region and a first peripheral edge;
a pliable cover material formed with a U shaped section extending at least partially along a second peripheral edge and arranged to fit over the core portion with the U shaped section extending over the first peripheral edge;
wherein the core portion and the pliable cover material are foldable about the hinge region so that the second peripheral edge of the pliable cover material forms a tucked edge.

2. The visor of claim 1 wherein the pliable material is formed by a slush molding process.

3. The visor of claim 1 further comprising a cushion layer disposed between the core portion and the pliable cover material.

4. The visor of claim 1 wherein the pliable cover material is selected from the group consisting of a vinyl, Santoprene®, a thermoplastic olefin, and a plastisol.

5. The visor of claim 1 further comprising an accessory coupled to the visor.

6. The visor of claim 1 wherein the folded core portion is secured together by at least one of heat staking, sonic welding, adhesives, press-fit connectors and snap-lock connectors.

7. The visor of claim 1 wherein the pliable cover material is formed with a first texture on a first side of the visor and a second texture on a second side of the visor.

8. The visor of claim 1 wherein the pliable cover material is formed as a multi-colored member.

9. The visor of claim 1 wherein the pliable cover material is made from one of a reaction injection molding process, a spray urethane process, a casting process and an extrusion process.

10. A method of making a visor, comprising:
providing a mold defining a cavity having a U shaped edge section;
introducing a material into the mold;
forming a pliable skin in the mold, the pliable skin having a return bend portion defined by the U shaped edge section of the cavity;
removing the pliable skin from the mold;
fitting the pliable skin over a foldable visor core with the return bend portion extending over an outer edge of the visor core;
folding the visor core to create a tucked edge appearance.

11. The method of claim 10 wherein the step of forming the pliable skin comprises slush molding.

12. The method of claim 10 wherein the step of forming the pliable skin comprises one of a reaction injection molding process, a spray urethane process, a casting process, a vacuum forming process and an extrusion process.

13. The method of claim 10 wherein the material is selected from the group consisting of a vinyl, Santoprene®, a thermoplastic olefin, and a plastisol.

14. The method of claim 10 further comprising securing adjacent halves of the folded visor core together to retain the return bend portions clamped between the adjacent halves.

15. The method of claim 10 wherein the cavity of the mold includes a first section having a first texture and a second section having a second texture so that a first side of the visor has the first texture and a second side of the visor has the second texture.

16. The method of claim 10 wherein the step of introducing a material comprises introducing a material having a first color and introducing a material having a second color.

17. A method of making a visor comprising:
providing a visor core having a hinge region and a first peripheral edge;
forming a visor cover having a flange extending at least partially along a second peripheral edge;
coupling the visor cover to the visor core so that the flange extends over the first peripheral edge; and
folding the visor cover and visor core about the hinge region so that the second peripheral edge forms a tucked edge.

18. The method of claim 17 wherein the flange creates a U shaped section.

19. The method of claim 17 wherein forming the visor cover comprises slush molding.

20. The method of claim 17 wherein forming the visor comprises slush molding a first material in a first mold portion and slush molding a second material in a second mold portion.

21. A visor for a vehicle, comprising:
a core portion having a first peripheral edge;
a cover preformed with a U shaped section extending at least partially along a second peripheral edge, the cover being fit over the core portion with the U shaped section fitted over the first peripheral edge to form a tucked edge along the second peripheral edge.
